(19) United States
(12) Patent Application Publication
(10) Pub. No.: US 2023/0059565 A1
(43) Pub. Date: Feb. 23, 2023

(54) DEMAND FORECASTING ENGINE IN A DATA ANALYTICS SYSTEM

(71) Applicant: The Boston Consulting Group, Inc., Boston, MA (US)

(72) Inventors: Arun Karthik Ravindran, Somerville, MA (US); Aaron Dean Arnoldsen, Beaverton, OR (US); Pradeep Nema, Redmond, WA (US); Michael Elliott Beyer, Porter, TX (US); Pawel Romanski, Warszawa (PL); Magdalena Jolanta Krupa, Warszawa (PL); Alejandro Fernandez Pique, Bacelona (ES); Aymeric Pascal Punel, Chicago, IL (US); Carl Reed Jessen, Spokane, WA (US); Wei Zou, San Jose, CA (US); Raman Deep Singh, Los Angeles, CA (US); Max Barkhausen, Berlin (DE); Remi Lalanne, Brooklyn, NY (US); Robert Andrew Fowler, Heidelberg (DE)

(21) Appl. No.: 17/853,605

(22) Filed: Jun. 29, 2022

Related U.S. Application Data
(60) Provisional application No. 63/234,424, filed on Aug. 18, 2021.

(51) Int. Cl. G06Q 30/02; G06N 20/00; G06Q 10/04

(52) U.S. Cl. CPC G06Q 30/0202; G06N 20/00; G06Q 10/04

(57) ABSTRACT

Methods, systems, and computer storage media for providing a dynamically weighted unobserved component model (“DW-UCM”) in a demand forecasting engine of a data analytics system. Dynamic weighting is performed based on a machine learning framework that includes tools, interfaces, and a library for developing improved machine learning models (e.g., dynamic demand forecasting models) of a dynamic weighting machine learning pipeline. In particular, the dynamic weighting machine learning pipeline can include a first module that is configured to predict if a segment (e.g., travel segment) under evaluation is open or closed (e.g., due to a restriction or rule), a second module that forecasts near-term recovery (e.g., approx. 0 - 4 weeks), and a third module that predicts longer term recovery. The demand forecasting engine — dynamic weighting machine learning pipeline — having the combination of modules allows the demand forecasting engine to compute near term movements in demand while also performing long-range scenario analysis.

### CROSS REFERENCE SECTION

The present application claims the benefit of U.S. Provisional Application No. 63/234,424, filed Aug. 18, 2021, and entitled “Demand Forecasting Engine in a Data Analytics System”, the entirety of which is incorporated by reference herein.

### BACKGROUND

Many companies rely on data analytics systems to support discovering useful information, informing conclusions and decision-making based on data. Data analytics systems can support forecasting — such as a forecasting system —that uses historical data as inputs to predict future trends. For example, businesses use forecasting systems to determine how to allocate budgets or plan anticipated expenses for upcoming periods of time. Forecasting systems can also be used for projecting demands for goods and services offered. Machine learning techniques implemented in forecasting systems allow for improving forecasting system operations including accelerating data processing speed, providing a more accurate forecast, automating forecasting updates based on recent data, analyzing more data, identifying hidden patterns in data, creating a more robust system, and increasing adaptability to changes. For example, a forecasting system can be used to forecast demand among origin-destination pairs for different types of travel systems.

Conventionally, data analytics systems are not equipped with a computing infrastructure and logic to support demand forecasting in volatile conditions. In particular, conventional data analytics systems do not dynamically weight unobserved components associated with travel to improve forecasting accuracy. For example, data analytics systems may implement generic machine learning techniques that are limited in techniques for identifying insights and using insights to make predictions. Moreover, these data analytics systems operate based on non-volatile historical data and lack support for intelligently understanding and using data associated volatility factors. As such, a more comprehensive data analytics systems — having an alternative basis for providing data analytics systems operations — can improve computing operations and interfaces in data analytics systems.

### SUMMARY

Various aspects of the technology described herein are generally directed to systems, methods, and computer storage media, for among other things, providing a dynamically weighted unobserved component model (“DW-UCM”) in a demand forecasting engine of a data analytics system. Dynamic weighting is performed based on a machine learning framework that includes tools, interfaces, and a library for developing improved machine learning models (e.g., dynamic demand forecasting models). The machine learning framework supports generating the DW-UCM and a dynamic weighting machine learning pipeline. In particular, the dynamic weighting machine learning pipeline can include a first module that is configured to predict if a segment (e.g., travel segment) under evaluation is open or closed (e.g., due to a restriction or rule), a second module that forecasts near-term recovery (e.g., approx. 0-4 weeks), and a third module that predicts longer term recovery. The demand forecasting engine (i.e., the dynamic weighting machine learning pipeline) having the combination of modules allows the demand forecasting engine to compute near term movements in demand while performing long-range scenario analysis. Operationally, the demand forecasting engine can be used to achieve better performance in travel forecasting (e.g., forecasting airline demand) from a given origin and destination pair (OD pair) — even in volatile conditions — because the machine learning framework and the DW-UCM improve forecast accuracy.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary data analytics system with a demand forecasting engine, in which embodiments described herein may be employed;

FIGS. 1C - 1F are exemplary schematics associated with data analytics system with a demand forecasting engine in which embodiments described herein may be employed;

FIGS. 2A and 2B are block diagrams of an exemplary data analytics system with a demand forecasting engine, in which embodiments described herein may be employed;

FIG. 3 is a flow diagram showing an exemplary method for implementing a data analytics system with a demand forecasting engine, in accordance with embodiments described herein;

FIG. 4 is a flow diagram showing an exemplary method for implementing a data analytics system with a demand forecasting engine, in accordance with embodiments described herein;

FIG. 5 is a flow diagram showing an exemplary method for implementing a data analytics system with a demand forecasting engine, in accordance with embodiments described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION OF THE INVENTION

### Overview

By way of background, forecasting systems use historical data as inputs to predict future trends. For example, businesses use forecasting systems to determine how to allocate budgets or plan anticipated expenses for upcoming periods of time. Machine learning techniques implemented in forecasting systems allow for improving forecasting system operations. Machine learning techniques and more generally forecasting systems utilize time series analysis. Time series analysis can refer to a specific way of analyzing a sequence of data points collected over an interval of time. In time series analysis, an analyst records data points at consistent intervals over a set period of time rather than simply recording the data points intermittently or randomly. Time series analysis sometimes aims to answer the question, if an observed series has been observed up until time (t), what function can assist in estimating what will happen at t+1 or t+10. This question is relevant in a variety of different applications (e.g., revenue forecasting or supply chain forecasting).

Conventionally, forecasting systems may implement an unobserved component model (UCM). A UCM decomposes a time series into trend, seasonal, cyclical, and idiosyncratic components and allows for exogenous variables. Each component is formulated as a stochastically evolving process over time. The decomposition of an observed time series into unobserved stochastic process can provide a better understanding of the dynamic characteristics of the series and the way these characteristics change over time. In this way, UCM can be implemented to identify patterns in historical demand in order to generate more accurate predictions.

Nonetheless, conventionally, forecasting systems can implement a UCM model that has several shortcomings. For example, predictive UCM models can be trained in batches and are unable to learn from mistakes. As such, forecasts are combined statically and often overlook market changes. And, because the UCM models treat demand as monolithic, the UCM models learn at only one level of granularity. Moreover, the UCM models make no attempt to adjust the data to the impact of recent events, as such the UCM models can become very static. In addition, UCM models can be trained to estimate demand, for example in travel, exclusively on historical booking data alone that can limit considering insights from different types of datasets. As such, a more comprehensive data analytics systems — having an alternative basis for providing data analytics systems operations — can improve computing operations and interfaces in data analytics systems.

Embodiments of the present disclosure are directed to providing systems, methods, and computer storage media, for among other things, providing a dynamically weighted unobserved component model (“DW-UCM”) in a demand forecasting engine of a data analytics system. Dynamic weighting is performed based on a machine learning framework that includes tools, interfaces, and a library for developing improved machine learning models (e.g., dynamic demand forecasting models). The machine learning framework supports generating the DW-UCM and a machine learning pipeline. In particular, the dynamic weighting machine learning pipeline can include a first module (e.g., probabilistic classifier) that is configured to predict if a segment (e.g., travel segment) under evaluation is open or closed (e.g., due to a restriction or rule), a second module (e.g., DW-UCM) that forecasts near-term recovery (e.g., approx. 0-4 weeks), and a third module (e.g., random forest regression model) that predicts longer term recovery. The dynamic weighting machine learning pipeline having the combination of modules allows the demand forecasting engine to compute near term movements in demand while also performing long-range scenario analysis.

By way of example, time series analysis can be useful in determining functions or models that support making predictions about future outcomes. With regard specifically to travel (e.g., airline travel), a demand forecasting system can be configured to help determine whether network planning has been optimized or how, in a time period associated with rapid change (“volatile time period”) to adjust ticket prices to maximize profits. Weights can be optimized for airlines network, to enable learning patterns across origin-destination pairs. Weights can be incrementally rebalanced with addition of new information. Weights can be balanced along different time granularities. Other variations and combinations of weighting to support travel demand forecasting via a DW-UCM are contemplated with embodiments described herein.

In operation, an underlying UCM model can be implemented in a data analytics system to operate with the demand forecasting engine. The UCM model is configured to predict patterns based on historical data. By way of context, determining the outcome for “t+n” where an observed series has been observed up until time (t),the UCM breaks down historical data into a number of aggregates to understand the individual factors that impact the rise and fall of demand. For example, the UCM can break down data streams into relevant components including the following: (1) seasonality: how demand changes per the time of year; (2) cycle: an impact of business cycles with unknown periods; (3) slope: recent increasing or decreasing trends in demand; (4) irregular effects: impact on demand caused by unanticipated market events; and (5) level: a baseline demand inherent in the market. Each of these components have a knowable pattern.

The demand forecasting engine operates to intelligently weight an impact each component has on historical demand patterns. The demand forecasting generates the weighted patterns and adds them back to the training process to generate final demand forecasts. The demand forecasting engine can specifically dynamically perform weighting operations. Operationally, the demand forecasting engine is configured to create a more dynamic model that predicts time-varying weights to combine components of a forecast. The demand forecasting engine recombines the forecast sub-components with predicted weights, using the weights to infer the most influential components of the forecast.

Advantageously, the demand forecasting engine improves on an underlying UCM model in that the demand forecasting engine provides a model — a dynamic demand forecast model or dynamic weighting machine learning pipeline — that is dynamic and flexible based on a three-stage framework that dynamically weights components to improve forecasting accuracy. The demand forecasting engine incrementally rebalances the weight of each component with the addition of new information. In addition, by learning across multiple model components and time, the model is able to capture changes in market behavior and the model can balance weights along different time granularities.

The demand forecasting engine does not rely on historical data alone and nor does it combine the weight of components statically; instead, the demand forecasting engine can implement a model that can includes diverse datasets when predicting component weights. In this way, the dynamic demand forecasting model supports dynamic weighting operations that break down the components and further adds noise terms as null hypothesis and uses machine learning techniques to learn weights based on forward-looking conditions. Dynamic weighting operations adaptively recombine the components based on current conditions, enabling the demand forecasting engine to react rapidly to changes in input data. In one implementation, the range of allowed weights can be increased and regularization can be increased to prevent overfitting. As discussed in more detail below, a UCM and DW-UCM (and other models) can be modular implementations that support selectively employing each model for generating demand forecasts.

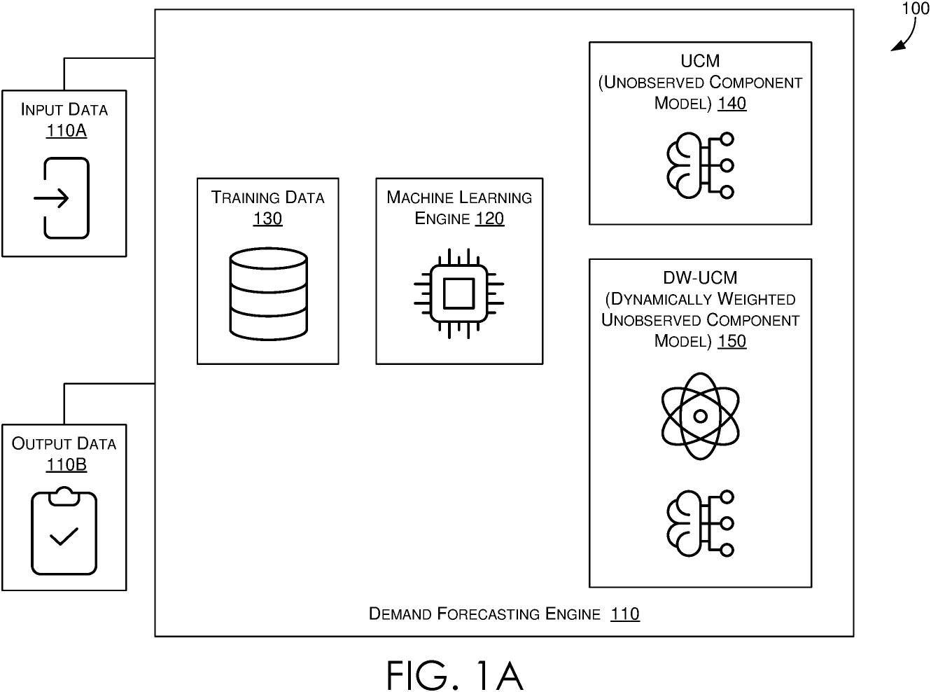

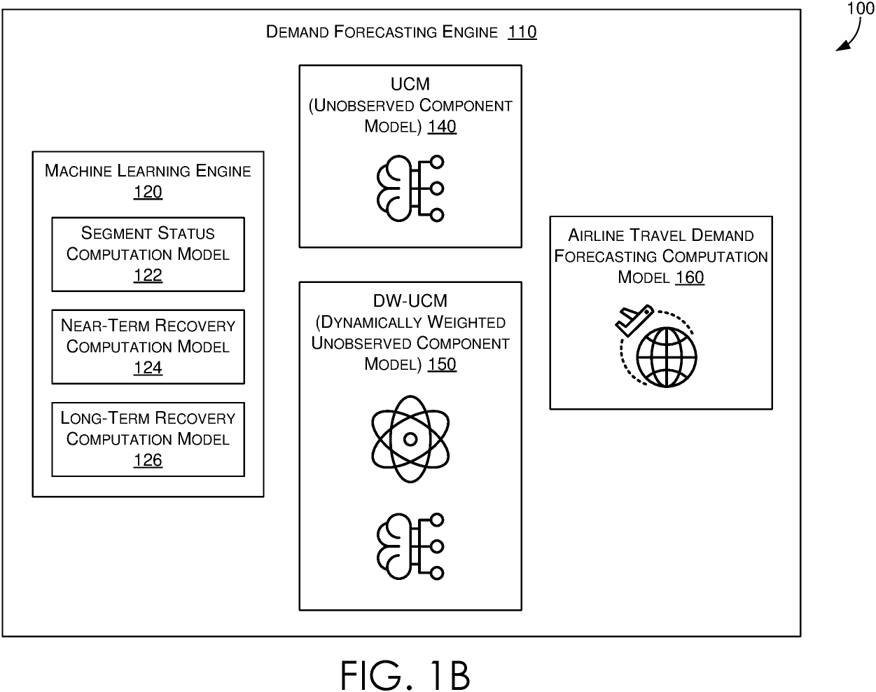

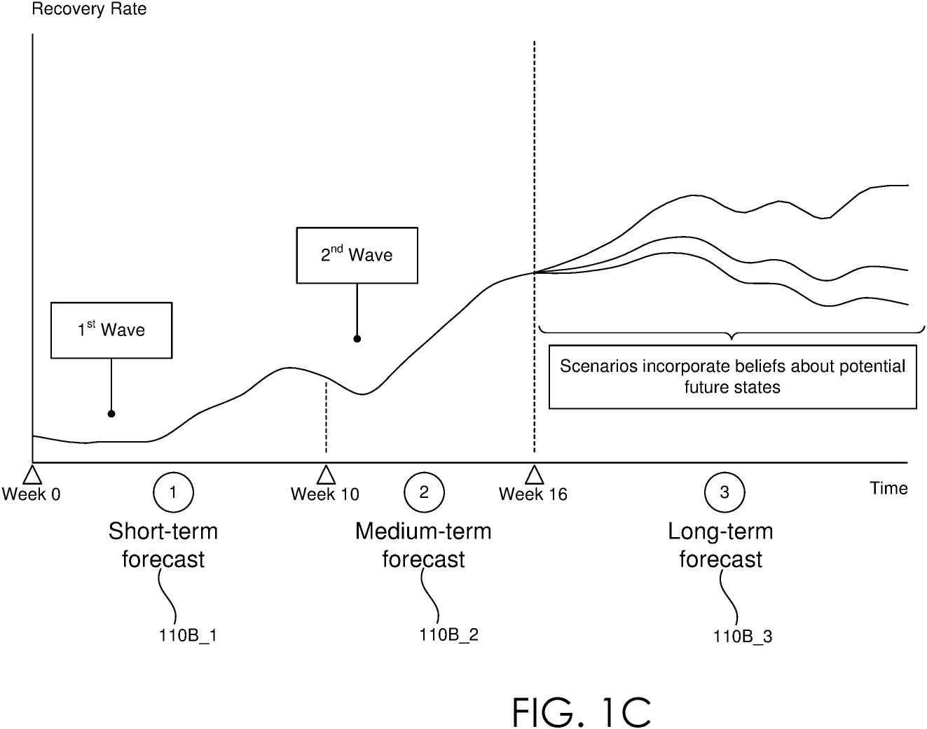

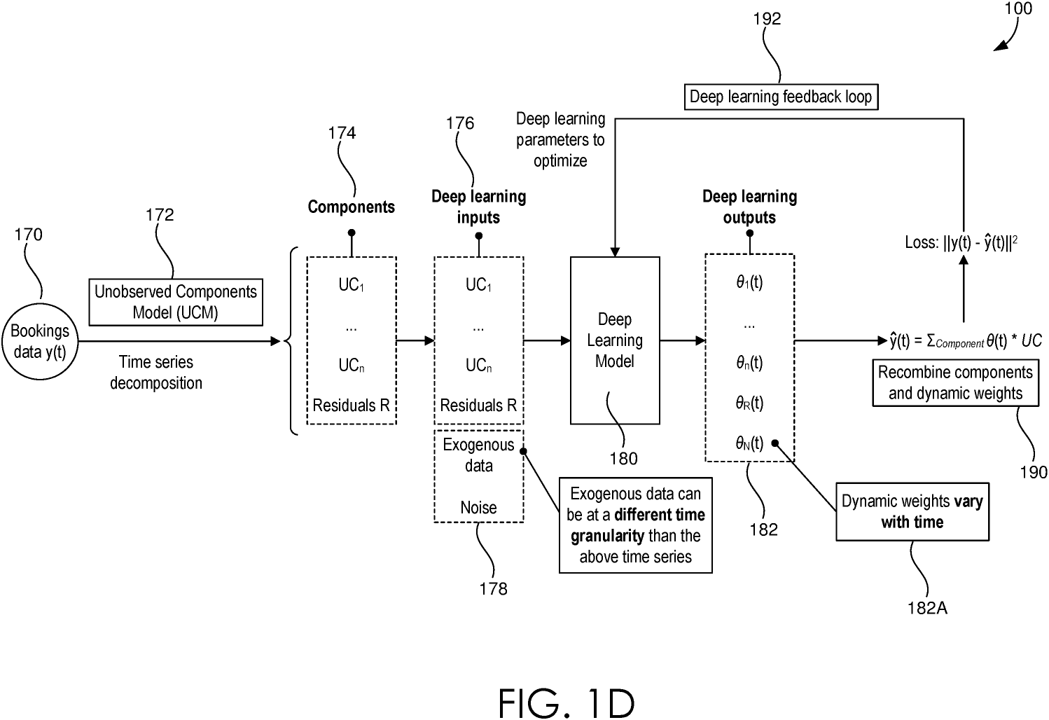

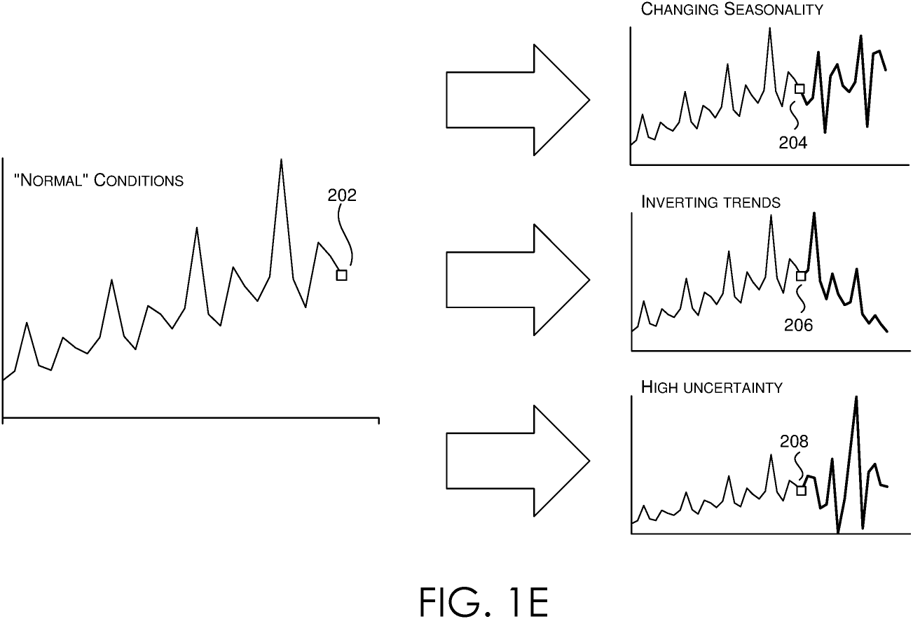

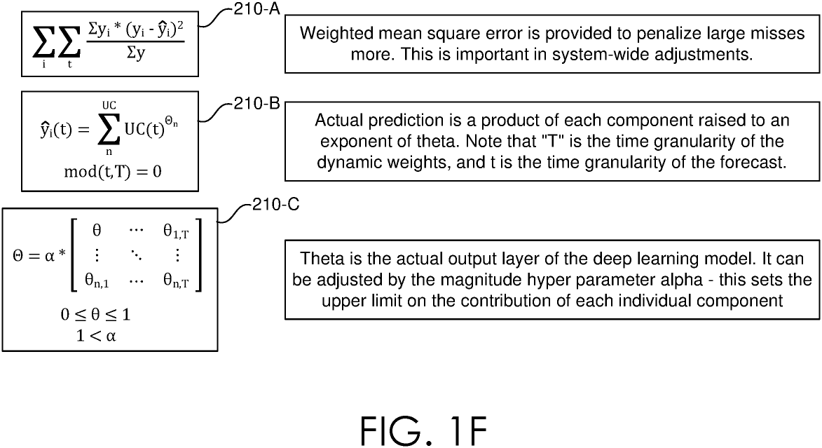

Aspects of the technical solution can be described by way of examples and with reference to FIGS. 1A, 1B, and 1C. FIG. 1A illustrates a data analytics system 100 -including input data 110A, output data 110B, demand forecasting engine 110 having machine learning engine 120, training data 130, UCM (unobserved component model) 140, DW-UCM (dynamically weighted unobserved component model) 150.

The demand forecasting engine 110 is responsible for generating a demand forecast using a dynamic weighting machine learning pipeline. The demand forecasting engine 110 accesses demand forecasting input data (i.e., input data 110A). For example, the input data 110A includes airline features (e.g., booking data and search data) and consumer mobility data. The input data 110 also includes booking data. The demand forecasting engine 110 implements the machine learning engine 120 uses training data 130 to train dynamic demand forecast models (i.e., a dynamic weighting machine learning pipeline). The demand forecasting engine 110 can include a training the UCM 140 and a dynamically weighted UCM are trained on the training data 110.

By way of example, a UCM model 140 (i.e., a time series forecasting mode) can be trained for forecasting time series data based on an additive model where non-linear trends can be fit with yearly, weekly and daily seasonality, plus holiday effects Training data 130 can be time series data that is collected at different points in time. As such, plotting the data points on a graph comprises on of the axes associated with time. Data points in time series data — that are collected in time series at adjacent time periods — have the potential for correlation between observations. Training data can specifically be Origin-Destination (OD) time series data associated with travel. OD time series data can represent movement through geographic space, from an origin (O) to a destination (D). In this way, OD datasets can contain details of trips associated with two geographic points, or more commonly, zones.

The UCM 140 and DW-UCM 150 can be modular implementations that support selectively employing each model for generating demand forecasts. The dynamic weighting machine learning pipeline can support determining that an origin-destination pair will be open for travel, and based on the demand forecasting input data, generate a demand forecast (i.e., output data 110B). As shown in FIG. 1C, a short-term approach leverages booking and search data, and various external data to capture recent changes in the market and provide strong predictive power in highly volatile demand. Medium-term approach captures potential downturns linked crisis incident progression and consumer activity. For long-term planning, the medium-term model can be used to estimate the recovery under multiple scenarios. As such, output data 110B can include different types of demand forecasts (e.g., short-term forecast 110B_1, medium-term forecast 110B_2, and long-term forecast 110B_3).

With reference to FIG. 1B, FIG. 1B illustrates aspects of the demand forecasting engine 110. FIG. 1B machine learning engine 120 having segment status computation model 122, near-term recovery computation model 124, long-term recovery computation model 126; UCM 140; DW-UCM 150; and airline travel demand forecasting computation model 160.

Dynamic weighting is performed based on a machine learning framework that includes tools, interfaces, and a library for developing improved machine learning models (e.g., dynamic demand forecasting models). In particular, the dynamic weighting machine learning pipeline can include a first module (i.e., segment status computation model 122) that is configured to predict if a segment (e.g., travel segment) under evaluation is open or closed (e.g., due to a restriction or rule), a second module (i.e., near-term recovery computation model 124) that forecasts near-term recovery (e.g., approx. 0 - 4 weeks), and a third module that predicts longer term recovery (i.e., long-term recover computation module). The dynamic weighting machine learning pipeline having the combination of modules allows the demand forecasting engine to compute near term movements in demand while performing long-range scenario analysis. The airline travel demand forecast computation model can employ the dynamic demand forecasting models specifically in an airline travel context to generate demand forecasts for airlines.

For longer-term forecasts, the demand forecasting engine 110 can implement a random forest regression model to fit a relationship between a consumer index and weekly booking activity. The random forest regression model can be applied to probabilistic forecasts of the consumer index, which is generated from a nonstationary Markov chain model fit to index movements over time. In this way, the demand forecasting engine includes dynamically weighting components to improve demand prediction.

By way of illustration, with reference to FIG. 1C, FIG. 1C illustrates recovery rate over time in a graphical schematic. Short-term forecast 110B_1 can correspond to week 0 thru week 10 indicating a first recovery wave; medium-term forecast 110B_2 can correspond to week 10 thru week 16 indicating a second recovery wave; and long-term forecast 110B_3 can correspond to week 16 and further in the future indicating scenarios that incorporate beliefs about potential future states.

Comparing a UCM to a DW-UCM yields a 10% mean absolute error improvement of the DW-UCM over the UCM. The DW-UCM, in particular benefits, from learning from recent mistakes based in part on steps that make the DW-UCM more flexible to changes in trend and seasonality. Testing data using the demand forecasting engine 110 has shown that dynamic weighting improved the mean absolute error over a short period by approximately 10%, as compared to conventional UCM models. In particular, the demand forecasting engine 110 improves the ability of a model to be reactive to recent trend changes, thus improving forecasting ability. Operationally, dynamic weighting predicted slightly higher values than the baseline, which helped it compensate for the increase in trend. The results demonstrate the dynamic model’s superior ability to adapt compared conventional UCM models.

With reference to FIG. 1D, FIG. 1D illustrates example aspects — block diagram representations — of the data analytics system 100 and demand forecasting engine 110. As discussed, input data (e.g., booking data 170) is provided as time series data and the UCM 172 decomposes the input data. Using demand forecasting engine 110 machine learning framework, weights can be based on forward looking conditions. UCM 172 decomposes the input data into a plurality of UCM components 174. The demand forecasting engine 110 supports dynamic weighting based on deep learning inputs (i.e., exogenous data, noise 178). The exogenous data can be at a different time granularity than the time series data. In this way, dynamic weighting specifically includes component breakdown with additional noise as a null hypothesis. The components can be adaptively recombined based on current conditions enabling demand forecasting engine 110 to react rapidly to changes in the market. As shown in FIG. 1E, normal condition trends are illustrated with graph 202, changing seasonality graph 204, inverting trends 206, and high uncertainty graph 208. It is contemplated that recombining components and dynamic weights can yield a loss that supports a deep learning feedback loop 192. Loss function - equations and justification are illustrated in FIG. 1F. Equation 210-A is associated with a weighted mean square error that is provided to penalize large misses more. Equation 210-B is associated with actual prediction. Equation 210-C provides theta, where theta is the actual output layer of the deep learning model. The deep learning feedback loop 192 comprises providing deep learning parameters to optimize the deep learning model 180.

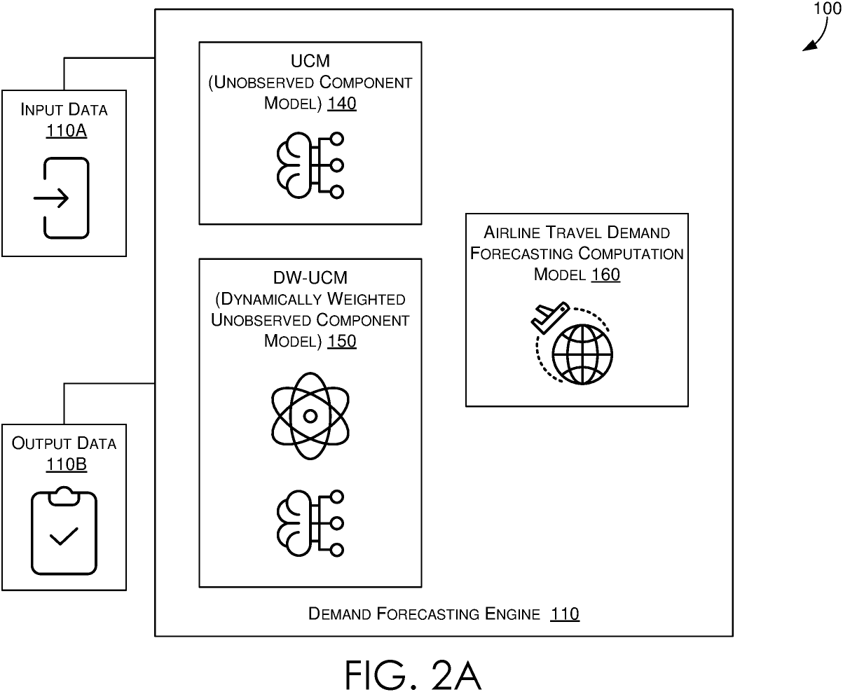

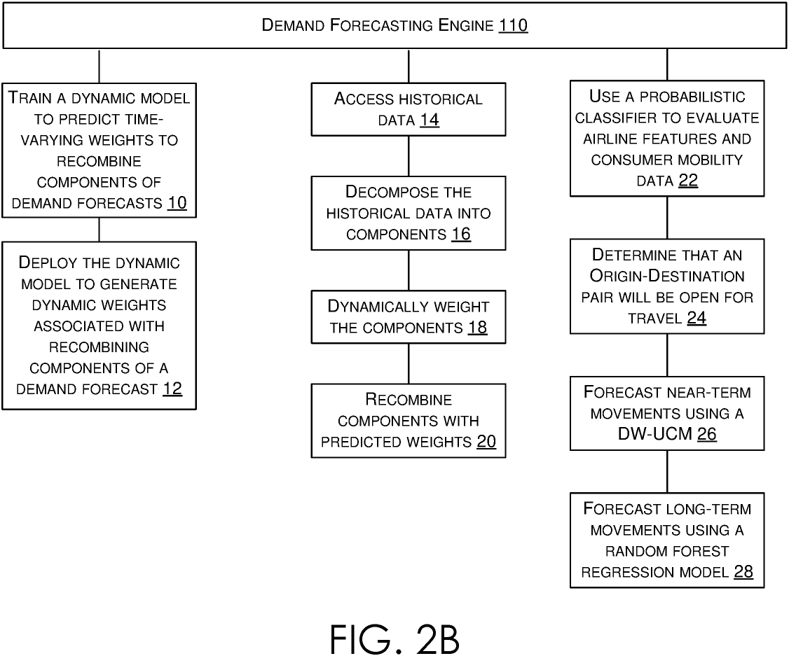

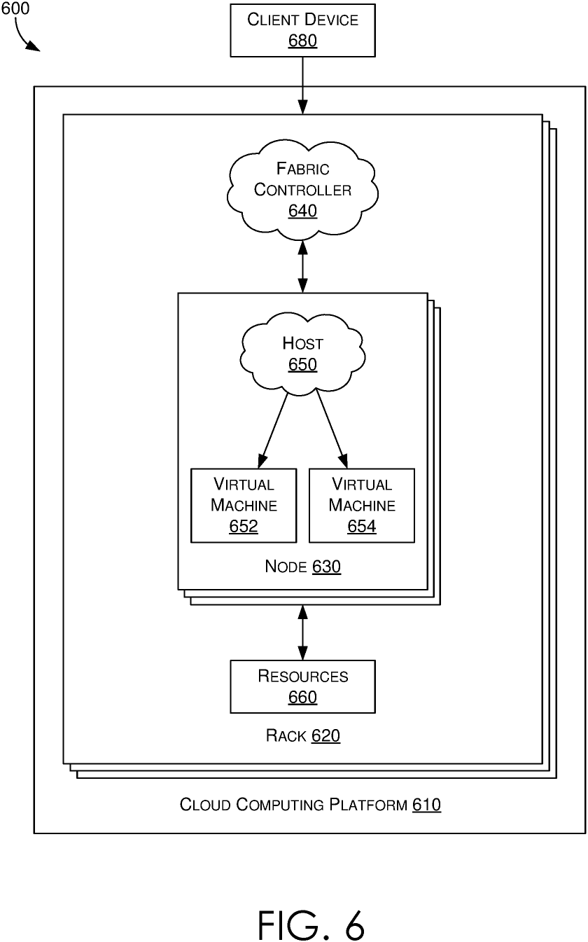

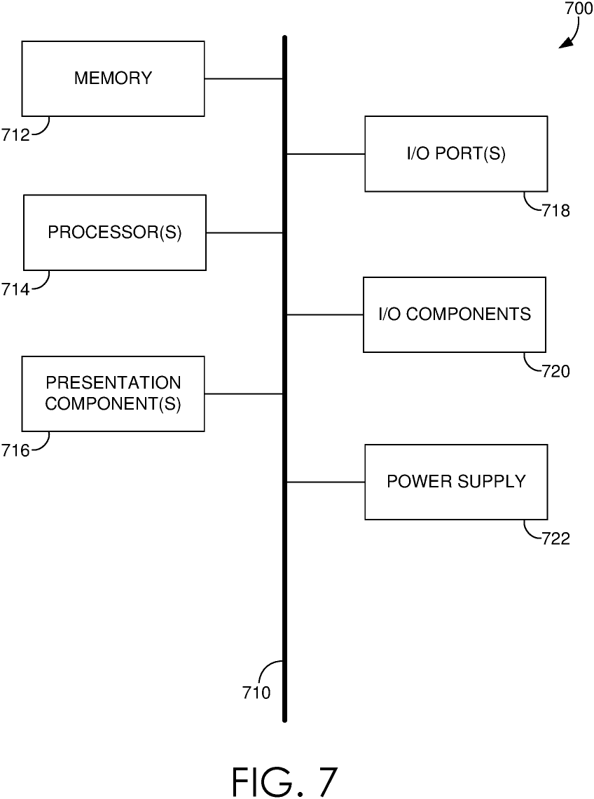

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally the technical solution environment includes a technical solution system suitable for providing the example data analytics system 100 in which methods of the present disclosure may be employed. In particular, FIG. 2A shows a high level architecture of the data analytics system 100 in accordance with implementations of the present disclosure. Among other engines, managers, generators, selectors, or components not shown (collectively referred to herein as “components”), the technical solution environment of data analytics system 100 corresponds to FIGS. 1A and 1B.

With reference to FIG. 2A, FIG. 2A illustrates data analytics system 100 including input data 110A, output data 110B, demand forecasting engine 110 having machine learning engine 120, UCM 140; DW-UCM 150; and airline travel demand forecasting computation model 160. Data analytics system 100 supports predictive analytics that use historical data as inputs to identify trends and relationships and predict future trends. Input data 100 can include historical data that used as input for generating demand forecasts. Historical data can include travel data associated with origin-destination pairs (e.g., time series data associated with travel) and consumer activity data and contextual data associated with the origin-destination pair geographic regions.

Output data 110B can include demand forecasts (e.g., final demand forecasts). For example, near-term recovery and long-term recovery forecast. Output data 110B can refer to other types of outputs (e.g., intermediate results data) from modules and models that operate as inputs into other modules and models for generating the demand forecasts. Output data can include dynamically generated weights for components and further include predictions that indicate whether a travel segment is open or closed.

Demand forecasting engine 110 is responsible for processing input data 110A (e.g., historical data) and generating output data (e.g., demand forecasts). In particular, the demand forecasting engine 110 can generate demand forecast for travel (e.g., airline travel). The demand forecasting engine 110 can include machine learning engine 120 that supports training, deploying, and employing different machine learning models. Operationally, developing a machine learning model for forecasting can be performed via a machine learning engine that supports gathering training data, defining goals and metrics associated with training data features or attributes (e.g., product features, time features etc.) Machine learning techniques can include Long Short-Term Memory (LSTM), Random Forest, and Linear Regression to develop forecasting models. For example, a linear regression approach can help predict future values from past values based on identifying underlying trends, so using historical data, additional information about the specific product, discounts, and average market cost, a prediction of a future value can be provided as a recommendation. The machine learning engine can further support training the forecasting models (i.e., using historical data and algorithms), validation (i.e., optimizing forecasting model parameters and hyper-parameters), and deployment (e.g., integration into production use).

Training data 130 can refer to data used to train different machine learning models described herein. Training data can include training data that corresponds to the type of data in input data (e.g., historical data) and training data can also include feedback data that is used to retrain machine learning models in the demand forecasting engine 110. Training data can be used to train UCM 140, DW-UCM 150 via machine learning engine 120. Machine learning engine 120 provides a machine learning pipeline that include the UCM 140, DW-UCM 150 and the airline travel demand forecasting computation model 160.

Segment status computation model 122 is a first module that is responsible for predicting if a segment (e.g., travel segment) under evaluation is open or closed. Near-term recovery computation model 124 is a second module that forecasts near-term recovery that forecast near-term recovery. Long-term recovery computation model 126 is a third module that predicts long-term recovery. Airline travel demand forecasting computation model 160 supports generating a final demand forecast specifically for airline travel. In particular, the airline travel demand forecasting computation model can support providing modular implementation of models of the demand forecasting engine that can used for specifically making airline travel demand forecasts. The demand forecasting engine 110 includes the DW-UCM that uses the airline travel demand forecasting computation model that examines a plurality features (e.g., travel or airline data features) and consumer mobility data.

By way of example, historical data can correspond to booking data for airline travel, where the historical data comprises airline features and consumer mobility data associated with origin-destination pairs. The dynamically weighted unobserved component model causes a probabilistic classifier to examine the airline features and the consumer mobility data to make demand forecasts. The demand forecasting engine 110 comprises a random forest regression model, the random forest regression model uses long-term recovery forecasts to fit a relationship between a consumer index and booking activity associated with a defined period of time to support predicting the weights. In this way, a demand forecast can be generated for an origin-destination pair.

With reference to FIG. 2B, FIG. 2B illustrates a demand forecasting engine 110. At block 12, train a dynamic model to predict time-varying weights to recombine components of a forecast. At block 14, deploy the dynamic model to generate dynamic weights associated with recombining components of a demand forecast 20. At block 14, access historical data. At block 42, decompose historical data into components. At block 16, dynamically weight the components. At block 18, recombine components with predicted weights. At block 22, use a probabilistic classifier to evaluate airlines features and consumer mobility data. At block 24, determine that an origin-destination pair will be open for travel. At block 26, forecast near-term movements using a DW-UCM. At block 28, forecast long-term movements using a DW-UCM.

### Example Methods

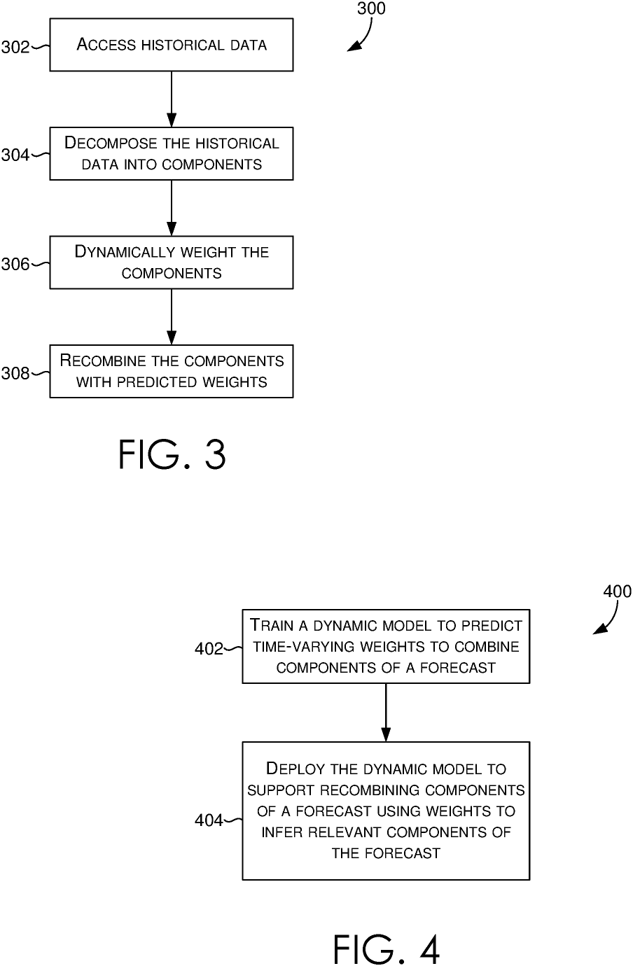

With reference to FIGS. 3, 4 and 5, flow diagrams are provided illustrating methods for providing a dynamically weighted unobserved component model (“DW-UCM”) in a demand forecasting engine of a data analytics system. The methods may be performed using the data analytics system described herein. In embodiments, one or more computer-storage media having computer-executable or computer-useable instructions embodied thereon that, when executed, by one or more processors can cause the one or more processors to perform the methods (e.g., computer-implemented method) in the data analytics system (e.g., a computerized system or computing system).

Turning to FIG. 3, a flow diagram is provided that illustrates a method 300 for providing a dynamically weighted unobserved component model (“DW-UCM”) in a demand forecasting engine of a data analytics system. At block 302, access historical data. At block 304, decompose the historical data into components. For example, historical data can be decomposed into predefined components including seasonality, trend, level, or exogenous effects (e.g., major sporting events). At block 306, dynamically weight the components using a dynamic model. In particular, the different components can be dynamically weighted to correspond with their predicted impact on forecast as their impact changes over time. Moreover, weights can be incrementally rebalanced with addition of new information. Weights can be balanced along different time granularities than individual forecasts. At block 308, recombine the components with predicted weights.

Turning to FIG. 4, a flow diagram is provided that illustrates a method 400 for providing a dynamically weighted unobserved component model (“DW-UCM”) in a demand forecasting engine of a data analytics system. At block 402, train a dynamic model to predict time-varying weights to combine components of a forecast. As discussed, different components can be dynamically weighted (e.g., based on predicted time-varying weights) to correspond with their impact on forecast changes over time. Advantageously, by learning across multiple model components and time, changes in behavior are captured. It is contemplated that weights can be optimized for a particular type of travel (e.g., airline travel). The dynamic model can be trained on a diverse data (e.g., not exclusively historical booking data) to increase the flexibility of the model. At block 404, deploy the dynamic model to support recombining components of a forecast using weights to infer relevant components of the forecast.

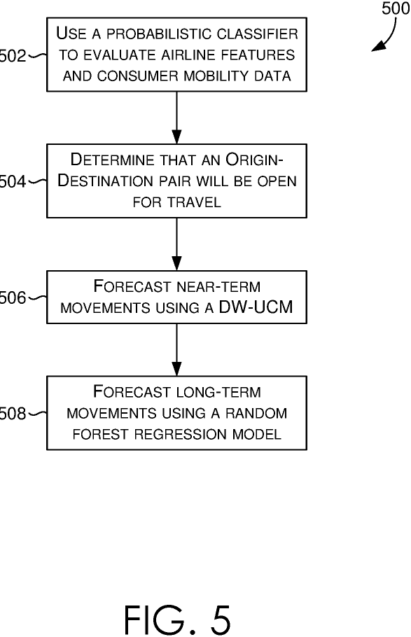

Turning to FIG. 5, a flow diagram is provided that illustrates a method 500 for providing a dynamically weighted unobserved component model (“DW-UCM”) in a demand forecasting engine of a data analytics system. At block 502, use a probabilistic classifier to evaluate airline features and consumer mobility data. At block 504, determine that an origin-destination pair will be open for travel. At block 506, forecast near-term movements using a DW-UCM. At block 508, forecast long-term movement using a random regression model.

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) running a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Computing Environment

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word "including" has the same broad meaning as the word "comprising," and the word "accessing" comprises "receiving," "referencing," or "retrieving." Further the word "communicating" has the same broad meaning as the word "receiving," or "transmitting" facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations comprising:
accessing, at a demand forecasting engine, historical data;
decompose the historical data into components;
using a dynamically weighted unobserved component model (DW-UCM) to dynamically weight components, wherein the dynamically weighted unobserved component model is a machine learning model that predicts weights; and
recombine components with the predicted weights.

2. The system of claim 1, wherein the historical data corresponds to booking data for airline travel, wherein the historical data comprises airline features and consumer mobility data associated with origin-destination pairs, wherein the dynamically weighted unobserved component model causes a probabilistic classifier to examine the airline features and the consumer mobility data to make demand forecasts.

3. The system of claim 1, wherein the demand forecasting engine comprises a machine learning engine, the machine learning engine comprises tools, interfaces, and a library for developing the dynamically weighted unobserved component model (DW-UCM) that calculates a weight that quantifies an impact of a component on historical demand patterns.

4. The system of claim 1, wherein the demand forecasting engine comprises a first module, a second module, and a third module, the first module determines whether a travel segment is open or closed; the second module forecasts near-term recovery; and the third module forecasts long-term recovery.

5. The system of claim 1, wherein the demand forecasting engine comprises a random forest regression model, the random forest regression model uses long-term recovery forecasts to fit a relationship between a consumer index and booking activity associated with a defined period of time to support predicting the weights.

6. The system of claim 1, wherein the demand forecasting engine comprises the dynamically weighted unobserved component model (DW-UCM) and an unobserved component model that are selectively implemented based on a requested demand forecast.

7. The system of claim 1, further comprising generating a demand forecast based for an origin-destination pair.

8. One or more computer-storage media having computer-executable instructions embodied thereon that, when executed by a computing system having a processor and memory, cause the processor to perform operations comprising:
accessing demand forecasting input data, wherein the demand forecasting input data comprises airline features and consumer mobility data;
determine that an origin-destination pair will be open for travel; and
based on the demand forecasting input data, generating a demand forecast using a dynamic weighting machine learning pipeline comprising a dynamically weighted unobserved component model (DW-UCM).

9. The media of claim 8, wherein the dynamic weighting machine learning pipeline comprises a probabilistic classifier that examines the airline features and the consumer mobility data for determining that the origin-destination pair will be open for travel.

10. The media of claim 8, wherein the dynamic weighting machine learning pipeline comprises a dynamically weighted unobserved component model (DW-UCM) that forecasts near-term recovery.

11. The media of claim 15, wherein the dynamic weighting machine learning pipeline comprises a random forest regression model that forecasts near-term recovery, the random forest regression model uses long-term recovery forecasts to fit a relationship between a consumer index and booking activity associated with a defined period of time to support predicting the weights.

12. The media of claim 15, wherein the demand forecasting engine comprises the dynamically weighted unobserved component model (DW-UCM) and an unobserved component model that are selectively implemented based on a requested demand forecast.

13. The media of claim 15, wherein the demand forecasting engine comprises the dynamically weighted unobserved component model (DW-UCM) and an unobserved component model that are selectively implemented based on a requested demand forecast.

14. The media of claim 15, wherein the dynamically weighted unobserved component model (DW-UCM) is trained based on a machine learning engine, the machine learning engine comprises tools, interfaces, and a library for developing the dynamically weighted unobserved component model (DW-UCM) that calculates a weight that quantifies an impact of a component on historical demand patterns.

15. A computer-implemented method, the method comprising:
accessing, at a demand forecasting engine, historical data, wherein the historical data is training data;
based on the historical data, training a dynamically weighted unobserved component model (DW-UCM), wherein the dynamically weighted unobserved component model is a machine learning model that predicts weights associated with recombining components of the demand forecasting engine, wherein the weights indicate a changing impact of the components in a forecast; and
deploying the DW-UCM to cause prediction of the weights that are used in data analytics operations associated with the demand forecasting engine.

16. The method of claim 15, wherein the historical data corresponds to booking data for airline travel, wherein the historical data comprises airline features and consumer mobility data associated with origin-destination pairs, wherein the dynamically weighted unobserved component model causes a probabilistic classifier to examine the airline features and the consumer mobility data to make demand forecasts.

17. The method of claim 15, wherein the demand forecasting engine comprises a first module, a second module, and a third module, the first module determines whether a travel segment is open or closed; the second module forecasts near-term recovery; and the third module predicts long-term recovery.

18. The method of claim 15, wherein the demand forecasting engine comprises the dynamically weighted unobserved component model (DW-UCM) and an unobserved component model that are selectively implemented based on a requested demand forecast.

19. The method of claim 15, the method further comprising
accessing demand forecasting input data, wherein the demand forecasting input data comprises airline features and consumer mobility data;
determine that an origin-destination pair will be open for travel; and
based on the demand forecasting input data, forecasting near term movements using a dynamically weighted unobserved component model (DW-UCM).

20. The method of claim 15, the method further comprising:
accessing, at a demand forecasting engine, historical data;
decompose the historical data into components;
using a dynamically weighted unobserved component model (DW-UCM) to dynamically weight components, wherein the dynamically weighted unobserved component model is a machine learning model that predicts weights; and
recombine components with the predicted weights.
